(19) United States
(12) Patent Application Publication
(10) Pub. No.: US 2011/0080823 A1
(43) Pub. Date: Apr. 7, 2011

(54) DISC STRUCTURE FOR BIT-WISE HOLOGRAPHIC STORAGE

(75) Inventors: Vicki Herzl Watkins, Alplaus, NY (US); Eugene Pauling Boden, Scotia, NY (US); Xiaolei Shi, Schenectady, NY (US); Kwok Pong Chan, Troy, NY (US); Victor Petrovich Ostroverkhov, Ballston Lake, NY (US); Matthew Jeremiah Misner, Delanson, NY (US)

(73) Assignee: GENERAL ELECTRIC COMPANY, SCHENECTADY, NY (US)

(21) Appl. No.: 12/966,144

(22) Filed: Dec. 13, 2010

Related U.S. Application Data
(63) Continuation-in-part of application No. 12/346,378, filed on Dec. 30, 2008.

(51) Int. Cl. G11B 7/24; B32B 38/04

(52) U.S. Cl. 369/275.1; 156/257; G9B/7.139

(57) ABSTRACT

An optical article is provided. The optical article includes a first layer. The first layer includes an active holographic layer configured to store holographic data. The first layer has a first surface and a second surface. A second layer includes a low birefringence material. The second layer also has a first surface and a second surface. Guide grooves are present in any one of the first layer or the second layer. In certain embodiments, the article may further include a reflective layer, an anti-reflective layer, a barrier layer, and a combination thereof.

### CROSS-REFERENCE TO RELATED APPLICATIONS

This application claims priority to non-provisional application Ser. No. 12/346,378 filed on Dec. 30, 2008, the entire contents of which are hereby incorporated by reference.

### BACKGROUND

The invention relates generally to bit-wise holographic storage. More particularly, the invention relates to a holographic disc structure with embedded tracks for real-time recording and readout.

As computing power has advanced, computing technology has entered new application areas, such as consumer video, data archiving, document storage, imaging, and movie production, among others. These applications have provided a continuing push to develop data storage techniques that have increased storage capacity. Further, increases in storage capacity have both enabled and promoted the development of technologies that have gone far beyond the initial expectations of the developers, such as gaming, among others.

The progressively higher storage capacities for optical storage systems provide a good example of the developments in data storage technologies. The compact disc, or CD, format, developed in the early 1980s, has a capacity of around 650-700 MB of data, or around 74-80 minutes of a two channel audio program. In comparison, the digital versatile disc (DVD) format, developed in the early 1990s, has a capacity of around 4.7 GB (single layer) or 8.5 GB (dual layer). The higher storage capacity of the DVD is sufficient to store full-length feature films at older video resolutions (for example, PAL at about 720 (h)×576 (v) pixels, or NTSC at about 720 (h)×480 (v) pixels).

However, as higher resolution video formats, such as high-definition television (HDTV) (at about 1920 (h)×1080 (v) pixels for 1080 p), have become popular, storage formats capable of holding full-length feature films recorded at these resolutions have become desirable. This has prompted the development of high-capacity recording formats, such as the Blu-ray Disc™ format, which is capable of holding about 25 gigabytes in a single-layer disc, or 50 gigabytes in a dual-layer disc. As resolution of video displays, and other technologies, continue to develop, storage media with ever-higher capacities will become more important. One developing storage technology that may meet the capacity requirements for some time to come is based on holographic storage.

Holographic storage is the storage of data in the form of holograms, which are images of three dimensional interference patterns created by the intersection of two beams of light in a photosensitive storage medium. Both page-based holographic techniques and bit-wise holographic techniques have been pursued. In page-based holographic data storage, a data beam which contains digitally encoded data is superposed on a reference beam within the volume of the storage medium resulting in a chemical reaction which, for example, changes or modulates the refractive index of the medium within the volume. This modulation serves to record both the intensity and phase information from the signal. Each bit is therefore generally stored as a part of the interference pattern. The hologram can later be retrieved by exposing the storage medium to the reference beam alone, which interacts with the stored holographic data to generate a reconstructed data beam proportional to the initial data beam used to store the holographic image.

In bit-wise holography or micro-holographic data storage, every bit is written as a micro-hologram, or reflection grating, typically generated by two counter propagating focused recording beams. The data is then retrieved by using a read beam to diffract off the micro-hologram to reconstruct the recording beam. Accordingly, micro-holographic data storage is more similar to current technologies than page-wise holographic storage. However, in contrast to the two layers of data storage that may be used in DVD and Blu-ray Disc™ formats, holographic discs may have 50 or 100 layers of data storage, providing data storage capacities that may be measured in terabytes (TB).

Although holographic storage systems may provide much higher storage capacities than prior optical systems, vibration and wobble of the holographic disc in an optical media player may be larger than a typical micro-hologram size. Consequently, vibration and wobble displacement of the spinning disc may cause problems in recording and readout of the optical disc.

Therefore, there is a need for improved, reliable, and economically feasible holographic data storage medium and methods through which enhanced holographic data storage capacities can be achieved.

### BRIEF DESCRIPTION

In one embodiment, an optical article is provided. The optical article includes a first layer. The first layer includes an active holographic layer configured to store holographic data. The first layer has a first surface and a second surface. A second layer includes a low birefringence material. The second layer also has a first surface and a second surface. Guide grooves are present in any one of the first layer or the second layer.

In another embodiment, an optical article is provided. The optical article includes a first layer. The first layer includes an active holographic layer configured to store holographic data. The first layer has a first surface and a second surface. A second layer includes a low birefringence material. The second layer also has a first surface and a second surface. Guide grooves are present in any one of the first layer or the second layer. A barrier coating is disposed over the second surface of the first layer and the first surface of the second layer.

In yet another embodiment, an optical article is provided. The optical article includes a first layer. The first layer includes an active holographic layer configured to store holographic data. The first layer has a first surface and a second surface. A second layer includes a low birefringence material. The second layer also has a first surface and a second surface. Guide grooves are present on the second surface of the first layer. The second surface of the first layer is adjacent to the first surface of the second layer.

In still yet another embodiment, an optical article is provided. The optical article includes a first layer. The first layer includes a low birefringence material. The first layer has a first surface and a second surface. A second layer includes an active holographic layer configured to store holographic data. The second layer also has a first surface and a second surface. Guide grooves are present on the second surface of the first layer. The second surface of the first layer is adjacent to the first surface of the second layer.

In still yet another embodiment, an optical article is provided. The optical article includes a first layer. The first layer includes a low birefringence material. A second layer includes an active holographic layer configured to store holographic data. A third layer includes a low birefringence material. The first layer, the second layer, and the third layer have a first surface and a second surface. Guide grooves are present on the first surface of the first layer. The first surface of the first layer is adjacent to the second surface of the second layer.

In still yet another embodiment, an optical article is provided. The optical article includes a first layer. The first layer includes a low birefringence material. A second layer includes an active holographic layer configured to store holographic data, which is disposed over the first layer. A third layer includes a low birefringence material, which is disposed over the second layer. A fourth layer includes an active holographic layer configured to store holographic data, which is disposed over the third layer. A fifth layer includes a low birefringence material is disposed over the second layer, which is disposed over the fourth layer. The first layer, the second layer, the third layer, the fourth layer, and the fifth layer have a first surface and a second surface. Guide grooves are present on the first surface of the first layer. The first surface of the first layer is adjacent to the second surface of the second layer.

In still yet another embodiment, a method is provided. The method includes the steps of providing a first layer, providing a second layer, disposing guide grooves on the first layer or the second layer, and binding the first layer and the second layer. The first layer includes an active holographic layer. The second layer includes a low birefringence material.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an optical article in accordance with embodiments of the present invention;

FIG. 2 is a schematic diagram of an optical article in accordance with embodiments of the present invention;

FIG. 3 is a schematic diagram of an optical article in accordance with embodiments of the present invention;

FIG. 4 is a schematic diagram of an optical article in accordance with embodiments of the present invention;

FIG. 5 is a schematic diagram of an optical article in accordance with embodiments of the present invention;

FIG. 6 is a schematic diagram of an optical article in accordance with embodiments of the present invention;

FIG. 7 is a schematic diagram of an optical article in accordance with embodiments of the present invention;

FIG. 8 is a schematic diagram of an optical article in accordance with embodiments of the present invention;

FIG. 9 is a block diagram of a method of manufacturing the optical article of FIG. 5 in accordance with embodiments of the present invention;

FIG. 10 is a schematic diagram of an optical drive used to record and/or read the optical article in accordance with embodiments of the present invention;

FIG. 11 is a schematic diagram for forming a hologram within an optical article in accordance with embodiments of the present invention; and

FIG. 12 is a schematic of a method of manufacturing the optical article of FIG. 5 in accordance with embodiments of the present invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function. These terms may also qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur—this distinction is captured by the terms “may” and “may be”.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” and “the,” are intended to mean that there are one or more of the elements. The terms “comprising,” “including,” and “having” are intended to be inclusive, and mean that there may be additional elements other than the listed elements. Furthermore, the terms “first,” “second,” and the like, herein do not denote any order, quantity, or importance, but rather are used to distinguish one element from another.

Embodiments of the invention described herein address the noted shortcomings of the state of the art. These embodiments advantageously provide an improved optical article. The optical article disclosed herein includes at least a first layer and a second layer. The first layer includes an active holographic layer configured to store holographic data. The first layer has a first surface and a second surface. The second layer includes a low birefringence material. The second layer also has a first surface and a second surface. Guide grooves are present in at least the first layer or the second layer. The first layer and the second layer are bound together by using a binding material. In one embodiment, the optical article disc structure described herein may be functional as a pre-formatted disc or a blank read/write disc for bit-wise micro-holograms. Again, in a micro-holographic system, the bit size is typically less than a micron. However, during real-time recording or readout, the disc has significant vibration and wobble, typically up to 100 micrometers. As the disc vibrates/wobbles by such a distance, the beam condition in the disc changes significantly and thus can't perform proper record and readout. With the guide grooves present in the optical article combined with an appropriate optical system, focusing and tracking can be performed and multi-layer micro-hologram record/read may be achieved in real-time. The disc structure disclosed herein may thereby allow for read-write of multiple layers of bit-wise micro-holograms at low and high numerical apertures for pre-formatted and/or blank discs. In certain embodiments, the optical article disc structure described herein will dramatically increase storage capacity from current Blu-ray formats of 25-50 gigabytes to about 500 to 1000 terabytes (TB) of information.

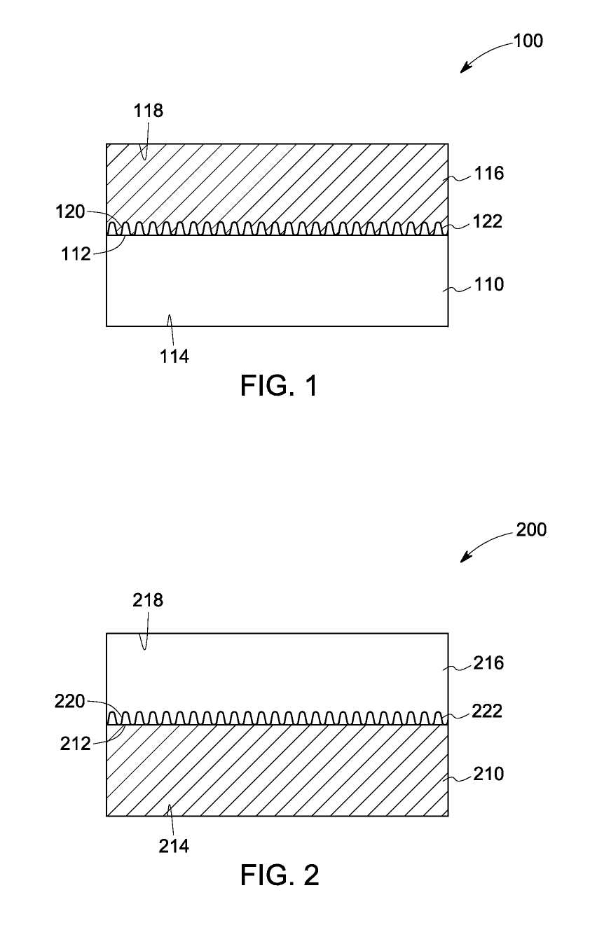

Referring to FIG. 1, in one embodiment, the invention includes an optical article 100. The optical article includes a first layer 110. The first layer 110 includes an active holographic layer configured to store holographic data. The first layer 110 has a first surface 112 and a second surface 114. A second layer 116 includes a low birefringence material. The second layer 116 also has a first surface 118 and a second surface 120. Guide grooves 122 are disposed on the second surface 120 of the second layer 116. The guide grooves 122 are adjacent to the first surface 112 of the first layer 110. This disc structure having two layers is a simple structure. The grooves in one of the layers give better control during the pre-formatting step and provide improved pre-formatting optics as known in the art. Additionally, the data may also be located relatively closer to the read-write surface.

Referring to FIG. 2, in one embodiment, the invention includes an optical article 200. The optical article includes a first layer 210. The first layer 210 includes a low birefringence material. The first layer 210 has a first surface 212 and a second surface 214. A second layer 216 includes an active holographic layer configured to store holographic data. The second layer 216 also has a first surface 218 and a second surface 210. Guide grooves 222 are disposed on the second surface 220 of the second layer 216. The guide grooves 222 are adjacent to the first surface 212 of the first layer 210.

In one embodiment, the active holographic layer may comprise a polymeric matrix and a threshold material that is optically-enabled. In one embodiment, the polymer matrix comprises a thermoplastic resin. Suitable thermoplastic resins include polycarbonate, a phenylene oxide based resin, a polyester resin, and a polyetherimide resin. In one embodiment, the optically-enabled material is a dye. In one embodiment, the dye includes a thermo-chromic material, an electro-chromic material, an energy transfer material, or any combination thereof. In one embodiment, the dye includes a reverse saturable (RSA) dye. Examples of such platinum class of dyes include, but are not limited to the following trans-platinum compounds: Bis(tributylphosphine)bis(4-ethynylbiphenyl)platinum (PPE), and Bis(tributylphosphine)bis(4-ethynyl-1-(2-phenylethynyl)benzene)platinum (PE2), Bis(1-ethynyl-4-(4-n-butylphenylethynyl)benzene)bis(tri-n-butyl)phosphine)Pt (II). (n-butyl PE2), bis(1-ethynyl-4-(4-fluorophenylethynyl)benzene)bis(tri-n-butyl)phosphine)Pt (II) (F-PE2), Bis(1-ethynyl-4-(4-methoxy-phenylethynyl)benzene)bis(tri-n-butyl)phosphine)Pt (II) (4-MeO-PE2), Bis(1-ethynyl-4-(4-methylphenylethynyl)benzene)bis(tri-n-butyl)phosphine)Pt(II)(Me-PE2), Bis(1-ethynyl-4(3,5-dimethoxyphenylethynyl)benzene)bis(tri-nbutylphosphine)Pt(II) (3,5-diMeO-PE2), Bis(1-ethynyl-4(4-N,N-dimethylaminophenylethynyl)benzene)bis(tri-n-butyl-phosphine)Pt(II) (diMeamino-PE2). Examples of suitable subphthalocyanines dye class include, but are not limited to, chloro[2,9,16-tribromosubphthalocyanato]boron(III), chloro[2,9,16-triiodosubphthalocyanato]-boron(III), chloro[trinitrosubphthalocyanato]boron(III), chloro[2,9,16-tri-tert-butyl- and chloro[2,9,17-tri-tert-butylsubphthalocyanato]boron(III), phenoxy-[subphthalocynato]boron(III), 3-bromophenoxy[subphthalocyanato]boron(III) 4-bromophenoxy[subphthalo-cyninato]boron(III), 3,5-dibromophenoxysubphthalo-cyaninato]boron(III), 3-iodophenoxysubphthalocyaninato]boron(III), 4-iodophenoxy[subphthalo-cyninato]boron(III), phenoxy[2,9,16-triiodosubphthalo-cyaninato]-boron(III), 3-iodophenoxy[2,9,16-triiodosubphthalocyaninato]-boron(III), and 4-iodophenoxy[2,9,16-triiodosubphthalocyaninato]boron(III). In general, threshold response is desirable from the materials for multi-layer micro-holographic storage. For a discussion of threshold materials of bit-wise holographic data storage, see U.S. Pat. No. 7,388,695, and US Patent Application 20080158627, incorporated herein by reference in their entirety.

In one embodiment, the active holographic layer has a thickness in a range from about 50 micrometers to about 1200 micrometers. In another embodiment, the active holographic layer has a thickness in a range from about 60 micrometers to about 1100 micrometers. In yet another embodiment, the active holographic layer has a thickness in a range from about 70 micrometers to about 1000 micrometers. In certain embodiments, where required a thinner disc may be formed since a thinner can be spun faster, when stabilized. On the other hand, in certain embodiments, a thicker disc may be formed. A thick disc is easier to handle and has better rigidity. Further, it may be relatively easy to form the spiral tracking pattern in a thicker layer.

In one embodiment, the low birefringence layer may function as the substrate layer in the optical article. Optical pick-up relies on correct detection of light polarization. Materials having high BR materials may scramble the polarization and undermine both detection and recording. In one embodiment, the low birefringence layer comprises a material having a transparency of greater than about 99 percent at wavelength of about 400 nanometers to about 420 nanometers. In one embodiment, the low birefringence layer comprises glass or a thermoplastic resin. The layer may be produced using methods known to one skilled in the art. Suitable methods of forming the second layer comprising a thermoplastic resin include solvent casting, spin coating, injection molding, and film/sheet extrusion.

In one embodiment, the low birefringence layer has a thickness in a range from about 2 micrometers to about 1200 micrometers. In another embodiment, the low birefringence layer has a thickness in a range from about 5 micrometers to about 1100 micrometers. In yet another embodiment, the low birefringence layer has a thickness in a range from about 10 micrometers to about 1000 micrometers. The variation in thickness may have the same advantages as discussed above for the thin and thick active holographic layers.

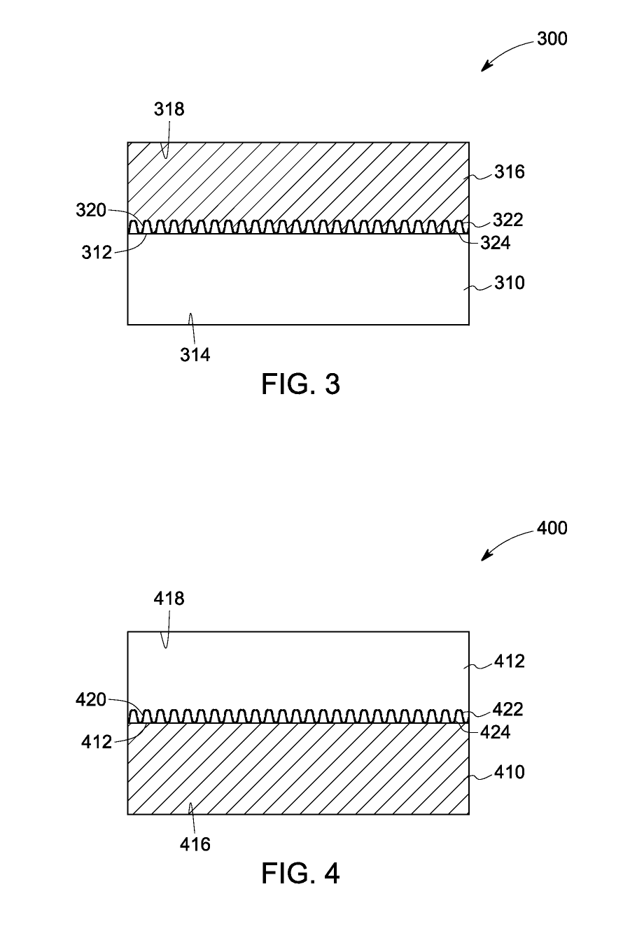

In certain embodiments, the optical article further comprises a reflective layer. In one embodiment, the reflective layer may be disposed over the guide grooves formed over the first layer or the second layer. Referring to FIG. 3, in one embodiment, the invention includes an optical article 300. The optical article includes a first layer 310. The first layer 310 includes an active holographic layer configured to store holographic data. The first layer 310 has a first surface 312 and a second surface 314. A second layer 316 includes a low birefringence material. The second layer 316 also has a first surface 318 and a second surface 320. Guide grooves 322 are disposed on the second surface 320 of the second layer 316. The guide grooves 322 are adjacent to the first surface 312 of the first layer 310. A reflective layer 324 may be disposed over the guide grooves 322. The reflective layer assists in tracking the guide grooves.

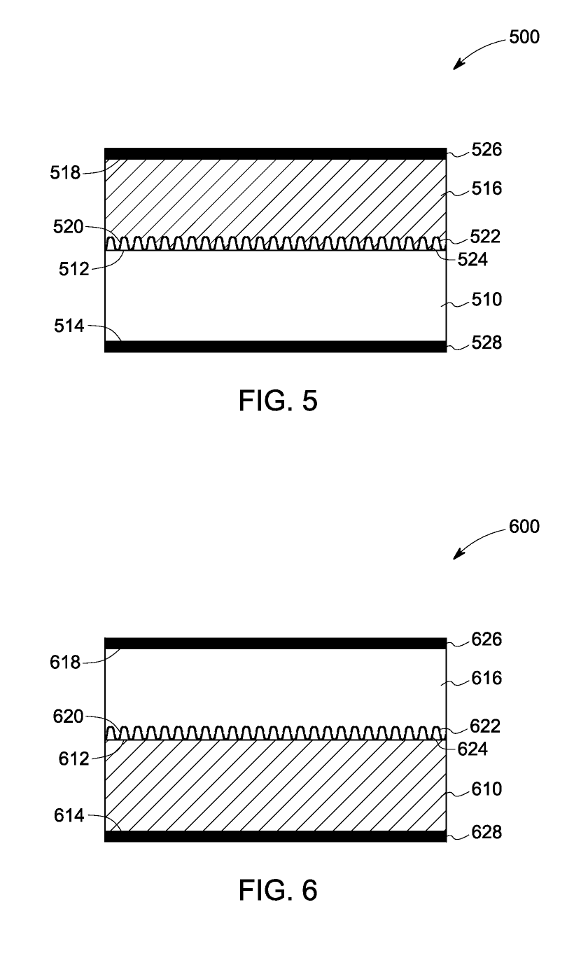

Referring to FIG. 4, in one embodiment, the invention includes an optical article 400. The optical article includes a first layer 410. The first layer 410 includes a low birefringence material. The first layer 410 has a first surface 412 and a second surface 414. A second layer 416 includes an active holographic layer configured to store holographic data. The second layer 416 also has a first surface 418 and a second surface 410. Guide grooves 422 are disposed on the second surface 420 of the second layer 416. The guide grooves 422 are adjacent to the first surface 412 of the first layer 410. A reflective layer 424 is disposed over the guide groves 422.

The reflective layer 324, 424 may help to enhance the reflection of a servo beam i.e., a tracking and focusing beam, from the grooves to provide an enhanced servo signals i.e., tracking and focusing signals. The reflective layer 324, 424 is configured generally to have reduced or no impact of the grooves on the record and readout beams, which may be at a different wavelength than the tracking beam. The reflective layer 324, 424 may even enhance transmission of the record and readout beams. The reflective layer 324, 424 may include layers of inorganic material. In one embodiment, metal oxides and metal nitrides may be employed as the reflective layer. Suitable inorganic materials that may be used as the reflective layer 324, 424 include titanium dioxide, silica, and silicon nitride. In various embodiments, the reflective layer 324, 424, may be deposited on the guide grooves 322, 422 by using methods known to one skilled in the art. Suitable deposition methods include vapor deposition, evaporation, sputtering, and the like.

In certain embodiments, the optical article further comprises an anti-reflective layer. In one embodiment, the anti-reflective layer may be disposed on the outside of the first layer and the second layer of the disc structure on surfaces opposite to the surface that comprises the guide grooves. The anti-reflective layer may help in reducing losses at the air interface when the laser beam is impinged on the optical article. Referring to FIG. 5, in one embodiment, the invention includes an optical article 500. The optical article includes a first layer 510. The first layer 510 includes an active holographic layer configured to store holographic data. The first layer 510 has a first surface 512 and a second surface 514. A second layer 516 includes a low birefringence material. The second layer 516 also has a first surface 518 and a second surface 520. Guide grooves 522 are disposed on the second surface 520 of the second layer 516. The guide grooves 522 are adjacent to the first surface 512 of the first layer 510. A reflective layer 524 may be disposed over the guide grooves 522. A first antireflective layer 526 may be disposed on the first surface 518 of the second layer 516 and a second antireflective layer 528 may be disposed on the second surface 514 of the first layer 510.

Referring to FIG. 6, in one embodiment, the invention includes an optical article 600. The optical article includes a first layer 610. The first layer 610 includes a low birefringence material. The first layer 610 has a first surface 612 and a second surface 614. A second layer 616 includes an active holographic layer configured to store holographic data. The second layer 616 also has a first surface 618 and a second surface 620. Guide grooves 622 are disposed on the second surface 620 of the second layer 616. The guide grooves 622 are adjacent to the first surface 612 of the first layer 610. A reflective layer 624 may be disposed over the guide grooves 622. A first antireflective layer 626 may be disposed on the first surface 618 of the second layer 616 and a second antireflective layer 628 may be disposed on the second surface 614 of the first layer 610.

In certain embodiments, the optical article may comprise a barrier layer. The barrier layer is typically disposed on the outer surface of any one or both the first layer and the second layer. The barrier layer typically functions as a moisture barrier, oxygen barrier or as a mechanical protection. In one embodiment, the barrier layer may comprise an organic material, an inorganic material, or a combination of inorganic and organic material. In one embodiment, the barrier layer may comprise alternating organic and inorganic materials. Suitable organic materials include polymers having a carbon linked backbone, such as for example parylene, acrylic polymer, and a styrene; polymers having silicon linked backbone, such as for example organosilane, organosilazane, and organosilicone; a styrene; a xylene; an alkene; and combinations thereof. Suitable inorganic materials include metal oxides, metal nitrides, and metal oxynitrides, such as for example alumina, zirconia, hafnia, silica, titanium nitride, aluminum nitride, silicon nitride, silicon oxynitride, and combinations thereof. In certain embodiments, the antireflective layer may function as the barrier layer. In certain embodiments, an additional barrier layer may be disposed over the anti-reflective layer on one or both sides of the device. As shown in FIGS. 5 and 6, in certain embodiments, anti-reflective layers 526, 528, 626, 628 may also function as a barrier layer.

In one embodiment, the optical article further comprises a bonding material disposed between the first layer and the second layer. Suitable bonding materials may include pressure sensitive adhesives, such as for example optically clear adhesive 8171 obtained from 3M; thermal adhesive, such as for example 302-2FL from epoxy technologies; and Ultraviolet (UV) curable adhesive, such as for example Norland products #72.

In one embodiment, the guide grooves 122, 222, 322, 422, 522, and 622, may be molded as part of the first layer 210, 410, and 610, or the second layer 116, 316, and 616. In one embodiment, the guide grooves may be stamped over the first layer or the second layer. The guide grooves may be disposed in various shapes. Suitable shapes include spiral tracks, wobble structures, synchronization marks, and any combination thereof.

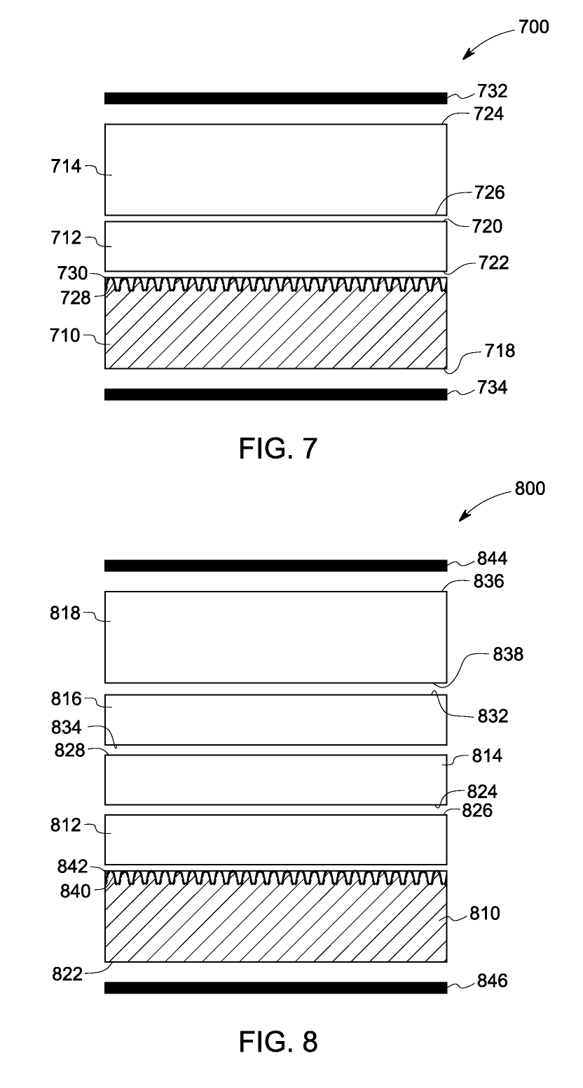

In still yet another embodiment, referring to FIG. 7, an optical article 700 is provided. The optical article 700 includes a first layer 710. The first layer 710 includes a low birefringence material. A second layer 712 includes an active holographic layer configured to store holographic data. A third layer 714 includes a low birefringence material. The first layer 710 has a first surface 716 and a second surface 718. The second layer 712 has a first surface 720 and a second surface 722. The third layer 714 has a first surface 724 and a second surface 726. Guide grooves 728 are present on the first surface 716 of the first layer 710. The first surface 716 of the first layer 710 is adjacent to the second surface 722 of the second layer 712. In certain embodiments, a reflective layer 730 may be disposed on the surface of the guide grooves 728. In certain other embodiments, an anti-reflective layer 732 may disposed on the second surface 718 of the first layer 710 and anti-reflective layer 734 may disposed on the first surface 724 of the third layer 714.

In still yet another embodiment, referring to FIG. 8, an optical article 800 is provided. The optical article 800 includes a first layer 810. The first layer 810 includes a low birefringence material. A second layer 812 includes an active holographic layer configured to store holographic data, which is disposed over the first layer 810. A third layer 814 includes a low birefringence material, which is disposed over the second layer 812. A fourth layer 816 includes an active holographic layer configured to store holographic data, which is disposed over the third layer 814. A fifth layer 818 includes a low birefringence material, which is disposed over the fourth layer 816. The first layer 810 has a first surface 820 and a second surface 822. The second layer 812 has a first surface 824 and a second surface 826. The third layer 814 has a first surface 828 and a second surface 830. The fourth layer 816 has a first surface 832 and a second surface 834. The fifth layer 818 has a first surface 836 and a second surface 838. Guide grooves 840 are disposed on the first surface 820 of the first layer 810. The first surface 820 of the first layer 810 is adjacent to the second surface 826 of the second layer 812. In certain embodiments, a reflective layer 842 may be disposed on the surface of the guide grooves 840. In certain other embodiments, an anti-reflective layer 846 may disposed on the second surface 822 of the first layer 810 and anti-reflective layer 844 may disposed on the first surface 836 of the fifth layer 818.

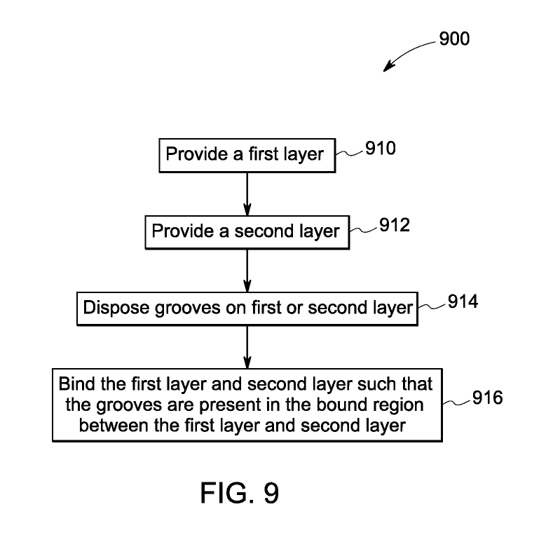

In one embodiment, referring to FIG. 9, a method 900 of forming the optical article is provided. The method includes a first step 910 of providing a first layer 110. The first layer has a first surface 112 and a second surface 114. A second step 912 includes providing a second layer 116. The second layer has a first surface 118 and a second surface 120. In a third step 914, guide grooves are disposed either in the first layer or in the second layer. In one embodiment, referring to FIG. 1, guide grooves 122 may be disposed over the second surface 120 of the second layer 116. In another embodiment, referring to FIG. 2, guide grooves 222 may be disposed over the second surface 220 of the second layer 216. Effectively the first layer and the second layer are bound in a manner such that the grooves are present in the bound region between the first layer and the second layer. As described above, the guide grooves may be directly stamped on the appropriate surface of the first layer or the second layer or molded on the first layer or the second layer during the formation of the first layer or the second layer. Referring to FIG. 1, the first layer 110 includes an active holographic layer and the second layer 116 includes a low birefringence material. Referring to FIG. 2, the first layer 210 includes a low birefringence material and the second layer 216 includes an active holographic layer. In a fourth step 916 the first layer 110, 210 and the second layer 116, 216, and bound together using a binding material (not shown in figures).

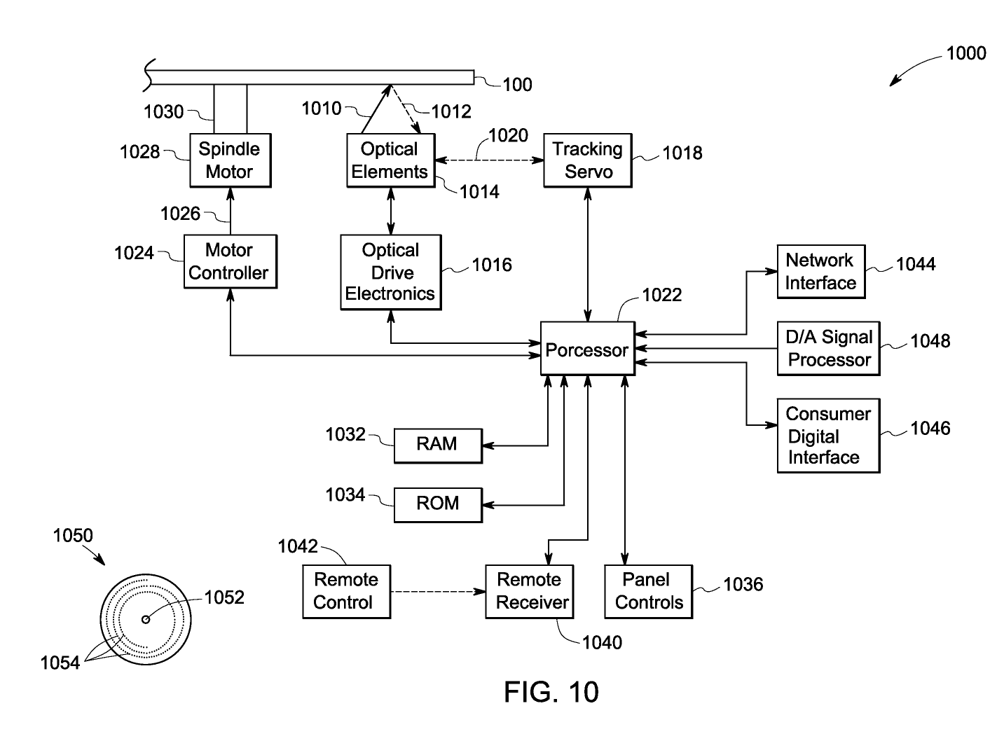

An optical drive system may be employed to read/write data from the optical article 100. Referring to FIG. 10, an optical drive system 1000 is provided. The optical drive system 1000 that may be used to record/read data from optical storage discs 100. The data stored on the optical article 100 is read by focusing a read beam 1010 onto the data in the optical article 100. A reflected beam 1012 from the data is picked up from the optical article 100 by the optical elements 1014. The optical elements 1014 may comprise any number of different elements designed to generate excitation beams, focus those beams in the optical article 100, and detect the reflection 1012 coming back from the data in the optical article 100. The optical elements 1014 are controlled through by an optical drive electronics package 1016. The optical drive electronics package 1016 may include such units as power supplies for one or more laser systems, detection electronics to detect an electronic signal from the detector, analog-to-digital converters to convert the detected signal into a digital signal, and other units such as a bit predictor to predict when the detector signal is actually registering a bit value stored on the optical article 100.

The location of some of the optical elements 1014 over the optical article 100 is controlled by a tracking servo 1018 through a mechanical actuator 1020 which is configured to move the optical elements back and forth over the surface of the optical article 100. The optical drive electronics 1016 and the tracking servo 1018 are controlled by a processor 1022. In some embodiments, the tracking servo 1018 or the optical drive electronics 1016 may be capable of determining the position of the optical elements 1014 based on sampling information received by the optical elements 1014.

The processor 1022 also controls a motor controller 1024 which provides the power 1026 to a spindle motor 1028. The spindle motor 1028 is coupled to a spindle 1030 that controls the rotational speed of the optical article 100. As the optical elements 1014 are moved from the outside edge of the optical article 100 closer to the spindle 1030, the rotational speed of the optical data disc may be increased by the processor 1022. This may be performed to keep the data rate of the data from the optical article 100 essentially the same when the optical elements 1014 are at the outer edge as when the optical elements are at the inner edge. The maximum rotational speed of the disc may be about 500 revolutions per minute (rpm), 1000 rpm, 1500 rpm, 3000 rpm, 5000 rpm, 10,000 rpm, or higher.

The processor 1022 is connected to random access memory or RAM 1032 and read only memory or ROM 1034. The ROM 1034 contains the programs that allow the processor 1022 to control the tracking servo 1018, optical drive electronics 1016, and motor controller 1024. Further, the ROM 1034 also contains programs that allow the processor 1022 to analyze data from the optical drive electronics 1016, which has been stored in the RAM 1032, among others. As discussed in further detail herein, such analysis of the data stored in the RAM 1032 may include, for example, demodulation, decoding or other functions necessary to convert the information from the optical article 100 into a data stream that may be used by other units.

If the optical drive system 1000 is a commercial unit, such as a consumer electronic device, it may have controls to allow the processor 1022 to be accessed and controlled by a user. Such controls may take the form of panel controls 1036, such as keyboards, program selection switches and the like. Further, control of the processor 1022 may be performed by a remote receiver 1038. The remote receiver 1038 may be configured to receive a control signal 1040 from a remote control 1042. The control signal 1040 may take the form of an infrared beam, an acoustic signal, or a radio signal, among others.

After the processor 1022 has analyzed the data stored in the RAM 1032 to generate a data stream, the data stream may be provided by the processor 1022 to other units. For example, the data may be provided as a digital data stream through a network interface 1044 to external digital units, such as computers or other devices located on an external network. Alternatively, the processor 1022 may provide the digital data stream to a consumer electronics digital interface 1046, such as a high-definition multi-media interface (HDMI), or other high-speed interfaces, such as a USB port, among others. The processor 1022 may also have other connected interface units such as a digital-to-analog signal processor 1048. The digital-to-analog signal processor 1048 may allow the processor 1022 to provide an analog signal for output to other types of devices, such as to an analog input signal on a television or to an audio signal input to an amplification system.

The drive 1000 may be used to read an optical article 100 containing data as shown in the top view 1050 of optical article 100. The optical article 100 is a flat, round disc with one or more data storage material layers embedded in a transparent protective coating. The protective coating may be a transparent plastic, such as polycarbonate, polyacrylate, and the like. Each of the data storage material layers may include any number of data layers that may reflect light. In micro-holographic data storage, a data layer includes micro-holograms. A spindle hole 1052 couples to the spindle (e.g., the spindle 1030 of FIG. 10) which controls the rotation speed of the optical article 100. In each layer, the data may be generally written in a sequential spiraling track 1054 from the outer edge of the optical article 100 to an inner limit, although circular tracks, or other configurations, may be used.

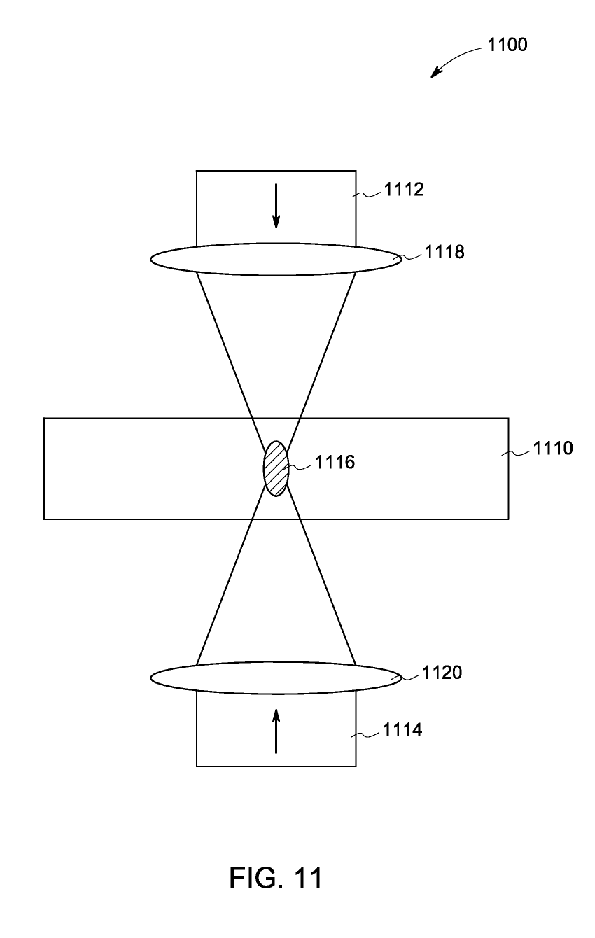

FIG. 11 shows an exemplary configuration 1100 for forming a hologram within an optical article 1110 using counter-propagating light beams. Micro-holographic recording results from two counter-propagating light beams 1112, 1114 interfering to create fringes in a volume 1116 of a recording medium 1110. Interference may be achieved by focusing light beams 1112, 1114 at nearly-diffraction-limited diameters (such as around 1 micrometer or smaller) at a target volume, e.g., desired location, within recording medium 1110. Light beams 1112, 1114 may be focused using a conventional lens 1118 for light beam 1112 and lens 1120 for light beam 1114. While simple lensing is shown, compound lens formats may of course be used. Methods for forming the hologram include methods described in US Patent Application 20080158627. In various embodiments, the micro-holograms in the optical articles discussed in FIGS. 1-6 can be formed in the active holographic layer in manner as described in FIG. 11.

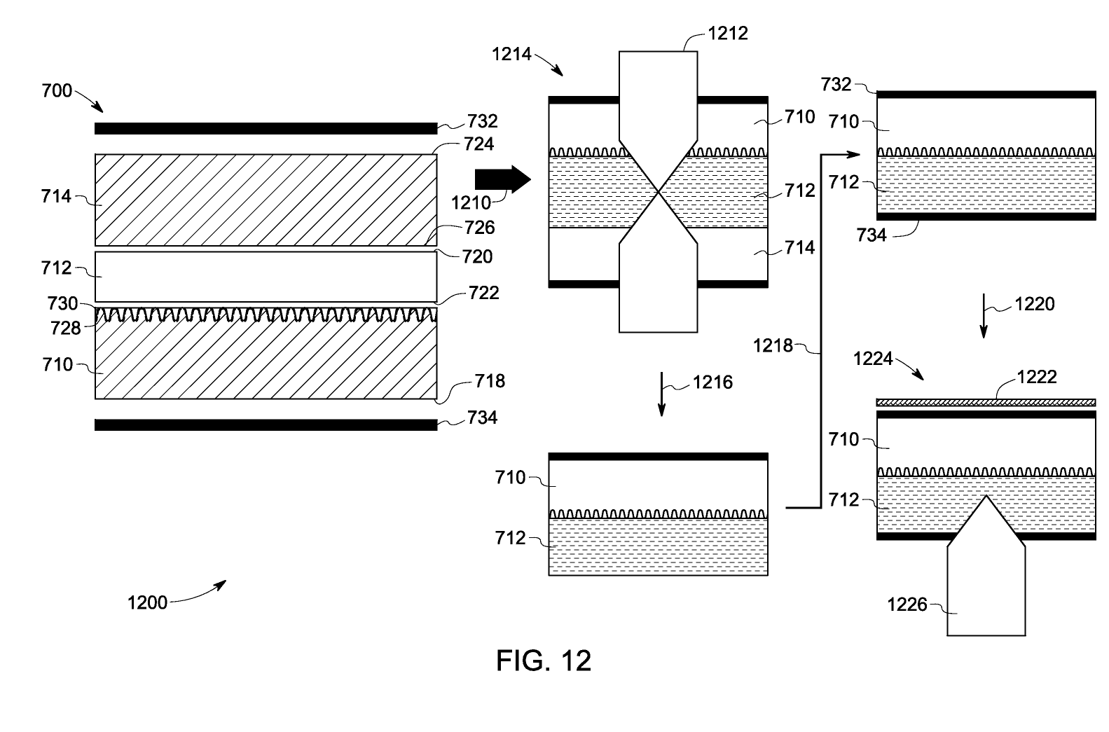

Referring to FIG. 12, an alternate method 1200 for forming an optical article 500 as shown in FIG. 5 is provided. The method 1200 includes a first step 1210 of providing an optical article 700 described in FIG. 7. The optical article 700 is then pre-formatted in a second step 1212 to form a pre-formatted optical article 1214. In a third step 1216 the third layer 714 is removed by thermal, mechanical or chemical dissolution of the interface bonding layer or the third layer itself, as known to one skilled in the art. In a fourth step 1218 an anti-reflective layer is disposed on the second surface 722 of the second layer 712. In a fifth step 1220 a protective coating layer 1222 to provide an optical article 1224 having a disc structure similar to that described in FIG. 5. The optical article 1224 may then be used as a read/write disc in a sixth step 1226.

In various embodiments the optical articles discussed herein may be employed as a pre-formatted disc or as a blank read/write disc for bit-wise micro-holograms. In certain embodiments, the optical articles discussed herein allow for read-write of multiple-layers of bit-wise micro-holograms at low and high numerical apertures for both pre-formatted disc or as a blank read/write disc. In various embodiments, the optical articles provided in FIGS. 1-6 above may be pre-formatted and used as read/write discs as described in FIG. 12 above. The optical articles 100, 200, 300, 400, 500, and 600 described in FIGS. 1-6 have only two layers and can be referred to asymmetric structures. As discussed above the grooves are disposed on one of the layers on a surface of the first or second layer which adjacent to a surface of the second or the first layer respectively. During pre-formatting the disc structure of the optical article enables the disposal of data close to the write/read surface, such as for example the exposed surface of the active holographic layer. The optical articles 700 and 800 described in FIGS. 7 and 8, may be referred to as symmetric structures.

In summary, the present technique may be directed to an optical disc for micro-holographic data storage. The disc may include optically-enabled material configured to store holographic data and guide grooves. The disc may include a first coating disposed on the guide grooves and configured to reflect a tracking beam and to transmit a read or record beam, and a second coating disposed to cover the guide grooves and disposed on the first coating. The optically-enabled material may have data layers of micro-holograms. The optically-enabled material may include a threshold material (e.g., a phase-change material, a energy transfer material, a thermo-chromic material, etc.) that is optically-enabled. The guide grooves may be molded as part of the optically-enabled material, and may include spiral tracks, wobble structures, or synchronization marks, or any combination thereof.

The disc may be manufacture as a holographic data storage disc. The disc may be molded (e.g., injection-molded) of holographic-enabled material in a disc shape with guide grooves. A first coating may be applied to the guide grooves, wherein the first coating is configured to reflect a tracking beam and to transmit a read or record beam. Applying the first coating may include depositing, evaporating, or sputtering a coating (e.g., dichroic coating) on the guide grooves, or any combination thereof. A second coating may be disposed (e.g., spin-coated) on the first coating to cover the guide grooves, wherein the second coating is dispose on the first coating.

In another example, a multi-layer optical disc for micro-holographic data storage, includes a substrate layer, at least one layer of optically-enabled material (e.g., thickness of about 0.1 millimeters to about 1.2 millimeters thick), and guide grooves. A coating disposed on the guide grooves and configured to reflect a tracking beam and to transmit a read or record beam. Further the disc may have an intermediate layer (e.g., not active) disposed between other layers of the disc, such as between two layers of optically-enabled material. Lastly, the guide groves may be disposed at different locations. For example, the guide grooves may disposed adjacent the substrate layer, the cover layer, or between layers of optically-enabled material, and so on.

A technique of recording, reading, and tracking a holographic data storage disc, includes: impinging a record beam on the holographic data storage disc to store or read a micro-hologram in a data region of the holographic data storage disc, wherein a width of the data region is at least 50 micrometers; impinging and reflecting a tracking beam on a guide groove of the holographic data storage disc, wherein the tracking beam comprises a different wavelength than the record beam and read beam; and detecting and analyzing the reflected tracking beam to control a position of the record beam or read beam on the holographic data storage disc.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An optical article comprising:
a first layer comprising an active holographic layer configured to store holographic data, wherein the first layer has a first surface and a second surface;
a second layer comprising a low birefringence material, wherein the second layer has a first surface and a second surface; and
guide grooves present in any one of the first layer or the second layer.

2. The article of claim 1, wherein the first layer has a thickness in a range from about 50 micrometers to about 1200 micrometers.

3. The article of claim 1, wherein the second layer has a thickness in a range of about 2 micrometers to about 600 micrometers.

4. The article of claim 1, wherein the guide grooves are present on the first surface of the first layer that is adjacent to the second surface of the second layer.

5. The article of claim 1, wherein the guide grooves are present on the second surface of the second layer that is adjacent to the first surface of the first layer.

6. The article of claim 1, further comprising a reflective layer.

7. The article of claim 6, wherein the reflective layer is disposed over the guide grooves.

8. The article of claim 1, further comprising an anti-reflective layer.

9. The article of claim 8, wherein the anti-reflective layer is disposed over the second surface of the first layer.

10. The article of claim 8, wherein the anti-reflective layer is disposed over the first surface of the second layer.

11. The article of claim 1, further comprising a barrier coating.

12. The article of claim 11, wherein the barrier coating is disposed over the second surface of the first layer.

13. The article of claim 11, wherein the barrier coating is disposed over the first surface of the second layer.

14. The article of claim 1, further comprising a bonding material disposed between the first layer and the second layer.

15. The article of claim 1, wherein the active holographic layer comprises:
a thermoplastic, and
a threshold material that is optically-enabled.

16. The article of claim 15, wherein the threshold material comprises a dye.

17. The article of claim 16, wherein the dye comprises a thermo-chromic material, an electro-chromic material, an energy transfer material, or any combination thereof.

18. The article of claim 15, wherein the thermoplastic comprises a polycarbonate, a phenylene oxide based resin, a polyester resin, or a polyetherimide resin.

19. The article of claim 1, wherein the guide grooves comprise spiral tracks, wobble structures, or synchronization marks, or any combination thereof.

20. An optical article comprising:
a first layer comprising an active holographic layer configured to store holographic data, wherein the first layer has a first surface and a second surface;
a second layer comprising a low birefringence material, wherein the second layer has a first surface and a second surface;
guide grooves present in any one of the first layer or the second layer; and
a barrier coating disposed over the second surface of the first layer and the first surface of the second layer.

21. An optical article comprising:
a first layer comprising an active holographic layer configured to store holographic data, wherein the first layer has a first surface and a second surface;
a second layer comprising a low birefringence layer; wherein the second layer has a first surface and a second surface; and
guide grooves; wherein the guide grooves are present on the second surface of the first layer; and wherein the second surface of the first layer is adjacent to the first surface of the second layer.

22. An optical article comprising:
a first layer comprising a low birefringence layer, wherein the first layer has a first surface and a second surface;
a second layer comprising an optically-enabled material configured to store holographic data; wherein the layer has a first surface and a second surface; and
guide grooves; wherein the guide grooves are present on the second surface of the first layer; and wherein the second surface of the first layer is adjacent to the first surface of the second layer.

23. An optical article comprising:
a first layer comprising a low birefringence layer;
a second layer comprising an optically-enabled material configured to store holographic data disposed over the first layer;
a third layer comprising a low birefringence layer disposed over the second layer;
wherein the first layer, the second layer, and the third layer have a first surface and a second surface; and
guide grooves; wherein the guide grooves are present on the first surface of the first layer; and wherein the first surface of the first layer is adjacent to the second surface of the second layer.

24. An optical article comprising:
a first layer comprising a low birefringence layer;
a second layer comprising an optically-enabled material configured to store holographic data disposed over the first layer;
a third layer comprising a low birefringence layer disposed over the second layer;
a fourth layer comprising an optically-enabled material configured to store holographic data disposed over the third layer;
a fifth layer comprising a low birefringence layer disposed over the fourth layer;
wherein the first layer, the second layer, the third layer, the fourth layer, and the fifth layer have a first surface and a second surface; and
guide grooves; wherein the guide grooves are present on the first surface of the first layer; and wherein the first surface of the first layer is adjacent to the second surface of the second layer.

25. The article of claim 1, wherein the active holographic layer comprises data layers comprising micro-holograms.

26. A method comprising:
providing a first layer comprising an active holographic layer configured to store holographic data, wherein the first layer has a first surface and a second surface;
providing a second layer comprising a low birefringence material, wherein the second layer has a first surface and a second surface;
disposing guide grooves in at least the first layer or the second layer; and
binding the first layer and the second layer.

27. The method of claim 26, wherein the guide grooves is molded as part of the first layer.

28. The method of claim 26, wherein the guide grooves is molded as part of the second layer.
